(19) United States
(12) Patent Application Publication
(10) Pub. No.: US 2021/0027157 A1
(43) Pub. Date: Jan. 28, 2021

(54) UNSUPERVISED CONCEPT DISCOVERY AND CROSS-MODAL RETRIEVAL IN TIME SERIES AND TEXT COMMENTS BASED ON CANONICAL CORRELATION ANALYSIS

(71) Applicants: NEC Laboratories America, Inc., Princeton, NJ (US); NEC Corporation, Tokyo (JP)

(72) Inventors: Yuncong Chen, Plainsboro, NJ (US); Hao Yuan, College Station, TX (US); Dongjin Song, Princeton, NJ (US); Cristian Lumezanu, Princeton Junction, NJ (US); Haifeng Chen, West Windsor, NJ (US); Takehiko Mizoguchi, Tokyo (JP)

(21) Appl. No.: 16/918,484

(22) Filed: Jul. 1, 2020

Related U.S. Application Data
(60) Provisional application No. 62/878,783, filed on Jul. 26, 2019.
(60) Provisional application No. 62/877,967, filed on Jul. 24, 2019.

(51) Int. Cl. G06N 3/08

(52) U.S. Cl. CPC G06N 3/08

(57) ABSTRACT

A system for cross-modal data retrieval is provided. The system includes a database for storing training sets of two different modalities of time series and free-form text comments as pairs of mixed modality data. The computer processing system further includes a neural network having a time series encoder and text encoder which are jointly trained using a canonical correlation analysis that finds transformations of feature vectors from among the pairs of mixed modality data such that correlated mixed modality data is emphasized in the two different modalities and uncorrelated mixed modality data is minimized. The feature vectors are obtained by encoding a training set of the time series using the time series encoder and encoding a training set of the free-form text comments using the text encoder.

### RELATED APPLICATION INFORMATION

This application claims priority to U.S. Provisional Patent Application Ser. No. 62/877,967, filed on Jul. 24, 2019, incorporated herein by reference in its entirety. The application also claims priority to U.S. Provisional Patent Application Ser. No. 62/878,783, filed on Jul. 26, 2019, incorporated herein by reference in its entirety.

### BACKGROUND

### Technical Field

The present invention relates to information processing and more particularly to unsupervised concept discovery and cross-modal retrieval in time series and text comments based on canonical correlation analysis.

### Description of the Related Art

Time series data are prevalent in the big-data era. One example is industrial monitoring where readings from a large number of sensors in an industrial facility (e.g. power plant) constitute time series that exhibit complex patterns. Algorithms have been designed to automatically analyze time series patterns and solve specific tasks, but these results are usually given without explanations that are understandable by human users. This significantly reduces the confidence users have on the results and limits the potential impact that automated analytics can have on the actual decision process.

### SUMMARY

According to aspects of the present invention, a computer processing system for cross-modal data retrieval is provided. The computer processing system includes a database for storing training sets of two different modalities of time series and free-form text comments as pairs of mixed modality data. The computer processing system further includes a neural network having a time series encoder and text encoder which are jointly trained using a canonical correlation analysis that finds transformations of feature vectors from among the pairs of mixed modality data such that correlated mixed modality data is emphasized in the two different modalities and uncorrelated mixed modality data is minimized. The feature vectors are obtained by encoding a training set of the time series using the time series encoder and encoding a training set of the free-form text comments using the text encoder. The computer processing system also includes a hardware processor for retrieving feature vectors corresponding to at least one of the two different modalities for insertion into a feature space together with at least one feature vector corresponding to a testing input relating to at least one of a testing time series and a testing free-form text comment, determining a set of nearest neighbors from among the feature vectors in the feature space based on distance criteria, and outputting testing results for the testing input based on the set of nearest neighbors.

According to other aspects of the present invention, a computer-implemented method for cross-modal data retrieval is provided. The method includes storing, in a database, training sets of two different modalities of time series and free-form text comments as pairs of mixed modality data. The method further includes jointly training a neural network having a time series encoder and text encoder using a canonical correlation analysis that finds transformations of feature vectors from among the pairs of mixed modality data such that correlated mixed modality data is emphasized in the two different modalities and uncorrelated mixed modality data is minimized. The feature vectors are obtained by encoding a training set of the time series using the time series encoder and encoding a training set of the free-form text comments using the text encoder. The method also includes retrieving feature vectors corresponding to at least one of the two different modalities for insertion into a feature space together with at least one feature vector corresponding to a testing input relating to at least one of a testing time series and a testing free-form text comment. The method additionally includes determining a set of nearest neighbors from among the feature vectors in the feature space based on distance criteria, and outputting testing results for the testing input based on the set of nearest neighbors.

According to yet further aspects of the present invention, a computer program product for cross-modal data retrieval is provided. The computer program product includes a non-transitory computer readable storage medium having program instructions embodied therewith, the program instructions executable by a computer to cause the computer to perform a method. The method includes storing, in a database, training sets of two different modalities of time series and free-form text comments as pairs of mixed modality data. The method further includes jointly training a neural network having a time series encoder and text encoder using a canonical correlation analysis that finds transformations of feature vectors from among the pairs of mixed modality data such that correlated mixed modality data is emphasized in the two different modalities and uncorrelated mixed modality data is minimized. The feature vectors are obtained by encoding a training set of the time series using the time series encoder and encoding a training set of the free-form text comments using the text encoder. The method also includes retrieving feature vectors corresponding to at least one of the two different modalities for insertion into a feature space together with at least one feature vector corresponding to a testing input relating to at least one of a testing time series and a testing free-form text comment. The method additionally includes determining a set of nearest neighbors from among the feature vectors in the feature space based on distance criteria, and outputting testing results for the testing input based on the set of nearest neighbors.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram showing an exemplary computing device, in accordance with an embodiment of the present invention;

FIG. 2 is a high level block diagram showing an exemplary training architecture, in accordance with an embodiment of the present invention;

FIG. 3 is a flow diagram showing an exemplary training method, in accordance with an embodiment of the present invention;

FIG. 4 is a block diagram showing an exemplary architecture of the text encoder 215 of FIG. 2, in accordance with an embodiment of the present invention;

FIG. 5 is a block diagram showing an exemplary architecture of the time series encoder 210 of FIG. 2, in accordance with an embodiment of the present invention;

FIG. 6 is a block diagram further showing a block of the method of FIG. 3, in accordance with an embodiment of the present invention;

FIG. 7 is a flow diagram showing an exemplary method for cross-modal retrieval, in accordance with an embodiment of the present invention;

FIG. 8 is a high level block diagram showing an exemplary system/method for providing an explanation of an input time series, in accordance with an embodiment of the present invention;

FIG. 9 is a high level block diagram showing an exemplary system/method for retrieving time series based on natural language input, in accordance with an embodiment of the present invention;

FIG. 10 is a high level block diagram showing an exemplary system/method for joint-modality search, in accordance with an embodiment of the present invention; and

FIG. 11 is a block diagram showing an exemplary computing environment, in accordance with an embodiment of the present invention.

### DETAILED DESCRIPTION OF PREFERRED EMBODIMENTS

Embodiments of the present invention are directed to unsupervised concept discovery and cross-modal retrieval in time series and text comments based on canonical correlation analysis.

Meaningful interpretation of time series often requires domain expertise. In many real-world scenarios, time series are tagged with comments written by human experts. Although in some cases the comments are no more than categorical labels, more often they are free-form natural texts. These expert-written comments are readable, elaborative and provide domain-specific insights. For example, a comment from a power plant operator may include a description of the shape of the anomalous signals, the root causes, the actions taken to correct the issue and the prediction of future status.

These are the type of high-quality and effective explanations on time series that users desire. In addition, the present invention provides an approach to search for relevant time series segments using text as query. Compared to traditional single-modality time series retrieval systems, using text that describes the properties of desired targets allows forming semantic/abstract and potentially complex queries in a natural way. This translates to higher accuracy of retrieving results that match the user's expectation, thus more time saving.

Furthermore, comment data has been accumulated in many facilities over the course of their operation. Despite the high cost of soliciting comments from experts, most of them are usually not re-used. The present invention provides an approach to extract values from historical comments that include valuable domain knowledge. Such domain knowledge often includes important concepts in this domain. In the context of power plant operation, the concepts can include “steam pressure” and “maneuver of turning off the valve”. In other words, the comments include materials for constructing a domain-specific knowledge base. The availability of associated time series in accordance with the present invention provides more possibility for concept discovery because of the additional view of the data.

One or more embodiments of the present invention provide a unified approach to address these problems. More concretely, one or more embodiments of the present invention provide the following capabilities: (1) retrieving relevant time series segments or text comments, given a potentially multi-modal query (i.e. time series segment and/or text description), and (2) automatically discovering common concepts underlying a multi-modal dataset.

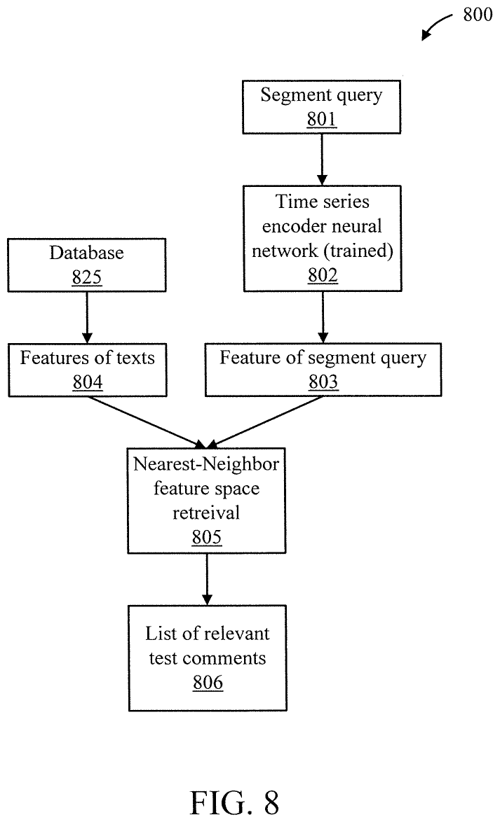

For the sake of illustration, three exemplary modes of using the present invention for retrieval are provided as follows and described in further detail hereinbelow with to FIGS. 8-10:

(1) Explanation: given a time series segment, retrieve relevant comments which can be used as human-readable explanations of the time series segment (FIG. 8).

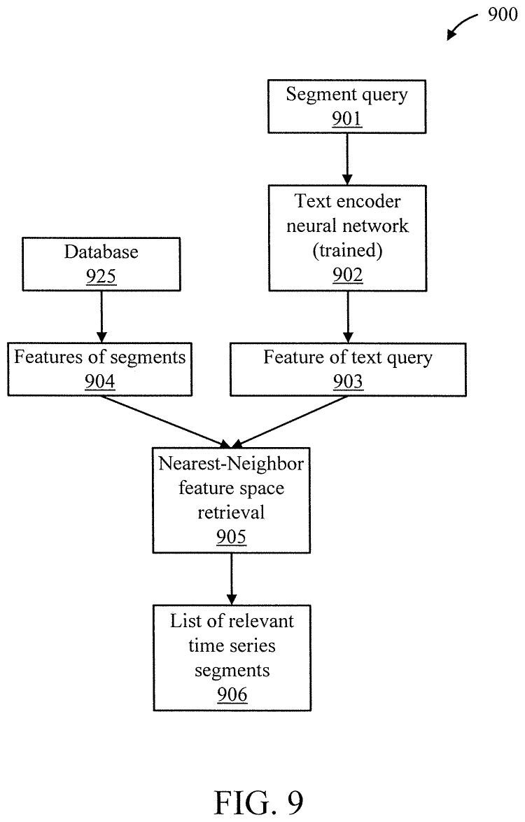

(2) Natural language search: given a sentence or set of keywords, retrieve relevant time series segments (FIG. 9).

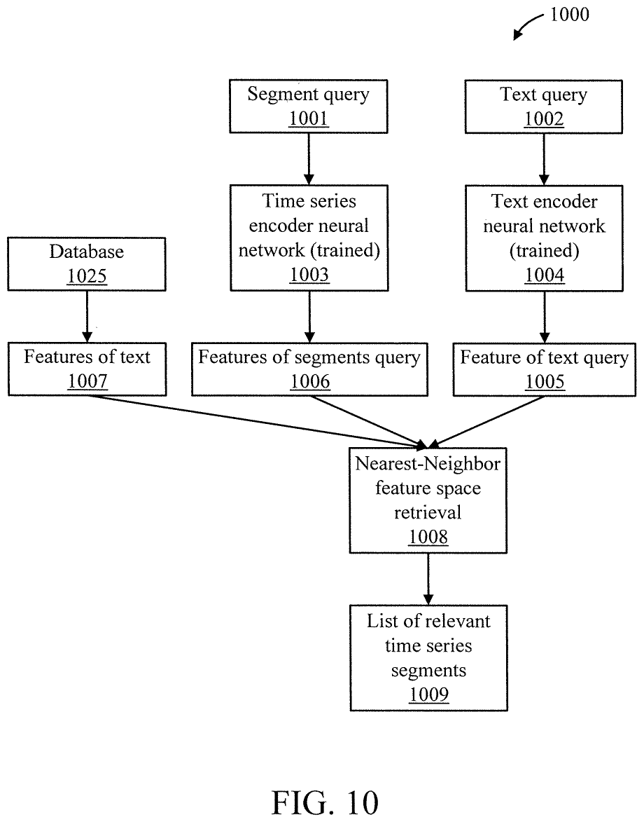

(3) Joint-modality search: given a time series segment and a sentence or a set of keywords, retrieve relevant time series segments such that a subset of the attributes match the keywords and the remaining of the attributes are similar to the given time series segment (FIG. 10).

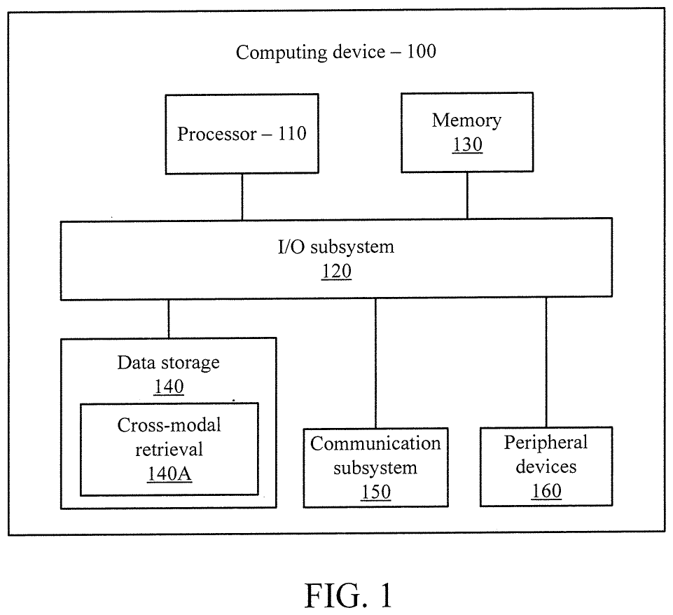

FIG. 1 is a block diagram showing an exemplary computing device 100, in accordance with an embodiment of the present invention. The computing device 100 is configured to perform concept discovery and cross-modal retrieval in datasets including time series segments and text comments based on canonical correlation analysis.

The computing device 100 may be embodied as any type of computation or computer device capable of performing the functions described herein, including, without limitation, a computer, a server, a rack based server, a blade server, a workstation, a desktop computer, a laptop computer, a notebook computer, a tablet computer, a mobile computing device, a wearable computing device, a network appliance, a web appliance, a distributed computing system, a processor-based system, and/or a consumer electronic device. Additionally or alternatively, the computing device 100 may be embodied as a one or more compute sleds, memory sleds, or other racks, sleds, computing chassis, or other components of a physically disaggregated computing device. As shown in FIG. 1, the computing device 100 illustratively includes the processor 110, an input/output subsystem 120, a memory 130, a data storage device 140, and a communication subsystem 150, and/or other components and devices commonly found in a server or similar computing device. Of course, the computing device 100 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 130, or portions thereof, may be incorporated in the processor 110 in some embodiments.

The processor 110 may be embodied as any type of processor capable of performing the functions described herein. The processor 110 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 130 may be embodied as any type of volatile or non-volatile memory or data storage capable of performing the functions described herein. In operation, the memory 130 may store various data and software used during operation of the computing device 100, such as operating systems, applications, programs, libraries, and drivers. The memory 130 is communicatively coupled to the processor 110 via the I/O subsystem 120, which may be embodied as circuitry and/or components to facilitate input/output operations with the processor 110 the memory 130, and other components of the computing device 100. For example, the I/O subsystem 120 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.) and/or other components and subsystems to facilitate the input/output operations. In some embodiments, the I/O subsystem 120 may form a portion of a system-on-a-chip (SOC) and be incorporated, along with the processor 110, the memory 130, and other components of the computing device 100, on a single integrated circuit chip.

The data storage device 140 may be embodied as any type of device or devices configured for short-term or long-term storage of data such as, for example, memory devices and circuits, memory cards, hard disk drives, solid state drives, or other data storage devices. The data storage device 140 can store program code for concept discovery and cross-modal retrieval in datasets including time series segments and text comments based on canonical correlation analysis. The communication subsystem 150 of the computing device 100 may be embodied as any network interface controller or other communication circuit, device, or collection thereof, capable of enabling communications between the computing device 100 and other remote devices over a network. The communication subsystem 150 may be configured to use any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 100 may also include one or more peripheral devices 160. The peripheral devices 160 may include any number of additional input/output devices, interface devices, and/or other peripheral devices. For example, in some embodiments, the peripheral devices 160 may include a display, touch screen, graphics circuitry, keyboard, mouse, speaker system, microphone, network interface, and/or other input/output devices, interface devices, and/or peripheral devices.

Of course, the computing device 100 may also include other elements (not shown), as readily contemplated by one of skill in the art, as well as omit certain elements. For example, various other input devices and/or output devices can be included in computing device 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 100 are readily contemplated by one of ordinary skill in the art given the teachings of the present invention provided herein.

As employed herein, the term “hardware processor subsystem” or “hardware processor” can refer to a processor, memory (including RAM, cache(s), and so forth), software (including memory management software) or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention

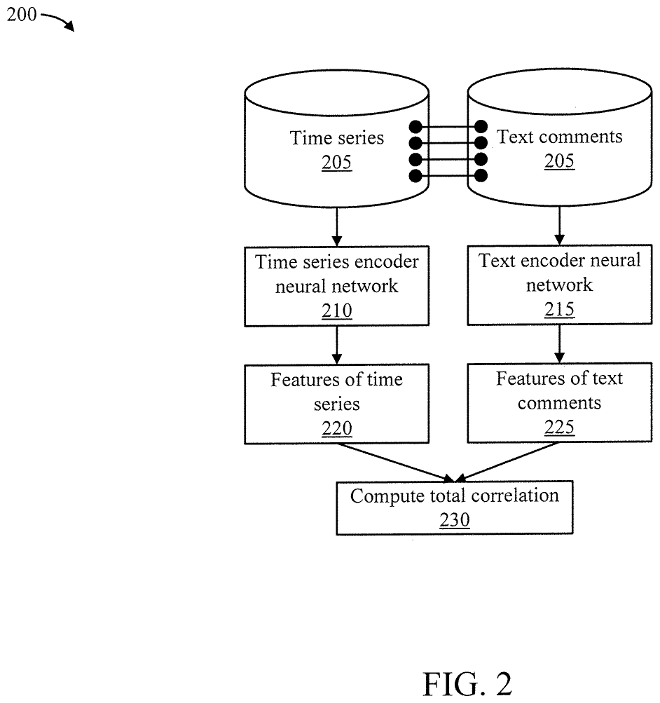

FIG. 2 is a high level block diagram showing an exemplary training architecture 200, in accordance with an embodiment of the present invention.

The training architecture 200 includes a database system 205, a time series encoder neural network 210, a text encoder neural network 215, features of the time series 220, features of the text comments 225, a total correlation computation function 230.

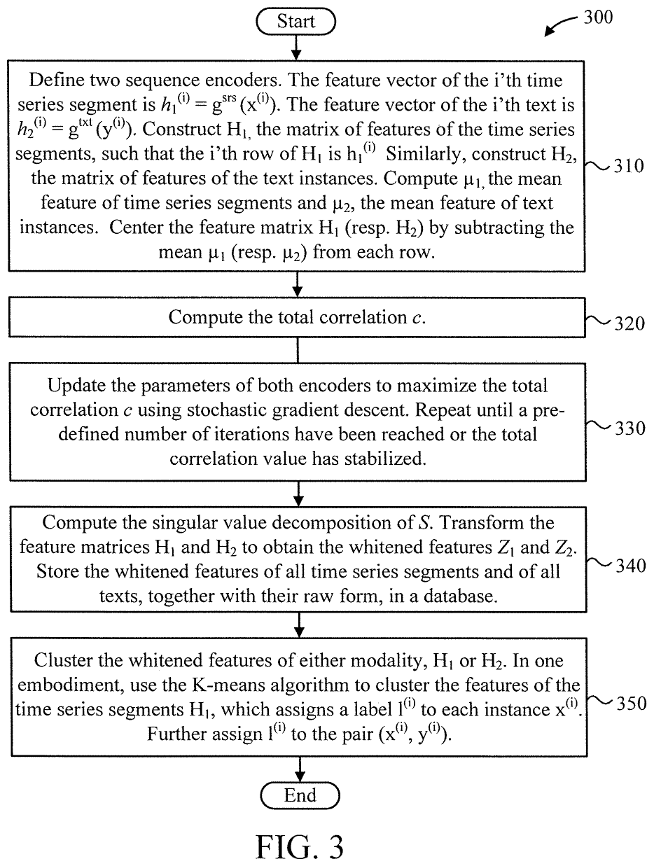

FIG. 3 is a flow diagram showing an exemplary training method 300, in accordance with an embodiment of the present invention.

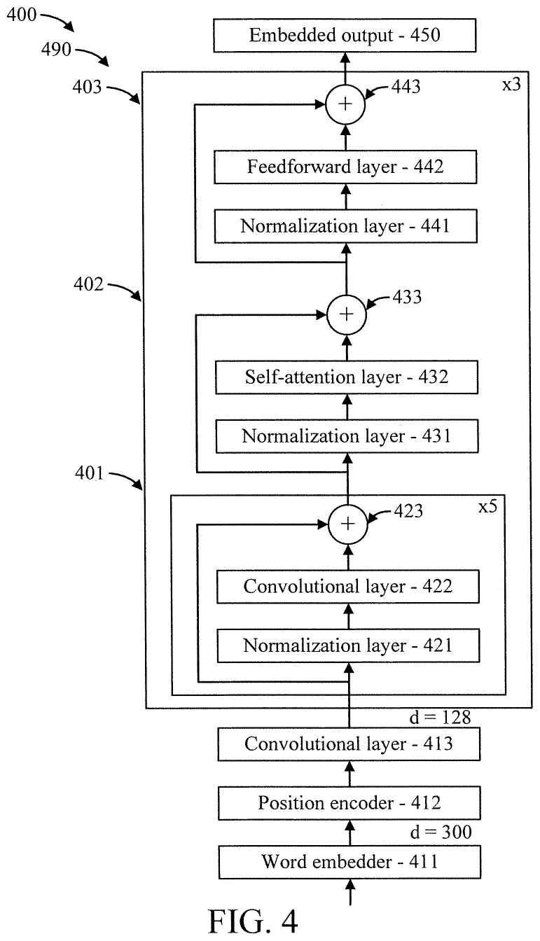

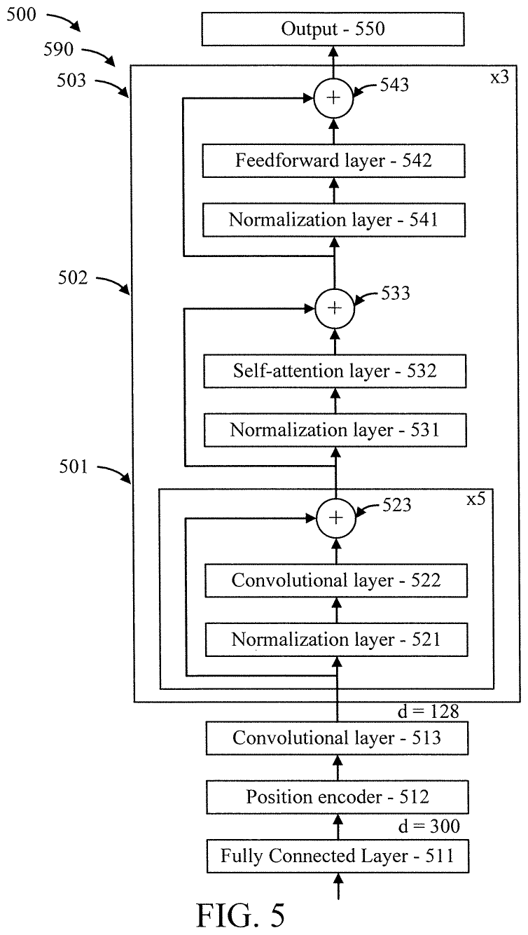

At block 310, define two sequence encoders. The text encoder 215, denoted by g^{txt}, takes the tokenized text comments as input. The time-series segment encoder 210, denoted by g^{srs}, takes the time series as input. The architecture of the text encoder 215 is shown in FIG. 4. The time-series encoder 210 has almost the same architecture as text encoder, except that the word embedding layer is replaced with a full connected layer as shown in FIG. 5. The encoder architecture includes a series of convolution layers followed by a transformer network. The convolution layers capture local contexts (e.g. phrases for text data). The transformer encodes the longer term dependencies in the sequence.

The feature vector of the i′th time series segment is h₁⁽ⁱ⁾=g^{srs} (x⁽ⁱ⁾). The feature vector of the i′th text is h₂⁽ⁱ⁾=g^{txt}(y⁽ⁱ⁾) Construct H₁, the matrix of features of the time series segments, such that the i′th row of H₁ is h₁⁽ⁱ⁾. Similarly, construct H₂, the matrix of features of the text instances.

Compute μ₁, the mean feature of time series segments and μ₂, the mean feature of text instances:

$${u}_{1} = \frac{1}{n} {\sum }_{i} {h}_{1}^{( i )} \\ {u}_{2} = \frac{1}{n} {\sum }_{i} {h}_{2}^{( i )}$$

Center the feature matrix H₁ (resp. H₂) by subtracting the mean μ₁ (resp. μ₂) from each row.

At block 320, compute the total correlation c, using the following formulas:

$${Σ}_{11} = \frac{{H}_{1}^{T} {H}_{1}}{n - 1} + {r}_{1} I$$

$${Σ}_{12} = \frac{{H}_{1}^{T} {H}_{2}}{n - 1}$$

$${Σ}_{22} = {H}_{2}^{T} {H}_{2} / ( n - 1 ) + {r}_{2} I$$

$$S = {Σ}_{11}^{- \frac{1}{2}} {Σ}_{12} {Σ}_{22}^{- \frac{1}{2}}$$

$$c = trace ( S {S}^{T} )$$

Here r₁ and r₂ are hyper-parameters controlling the strength of regularization, and I is an identity matrix.

At block 330, update the parameters of both encoders to maximize the total correlation c using stochastic gradient descent. Repeat until a pre-defined number of iterations have been reached or the total correlation value has stabilized.

At block 340, compute the singular value decomposition of S as follows:

U,Λ,V^{T}=SVD(S)

Transform the feature matrices H₁ and H₂ to obtain the whitened features Z₁ and Z₂:

$${z}_{1} = {H}_{1} {Σ}_{11}^{- \frac{1}{2}} U$$

$${z}_{2} = {H}_{2} {Σ}_{22}^{- \frac{1}{2}} V$$

Whitening is a generalization of feature normalization, which makes the input independent by transforming it against a transformed input covariance matrix.

Store the whitened features of all time series segments and of all texts, together with their raw form, in a database.

At block 350, cluster the whitened features of either modality, H₁ or H₂. In one embodiment, use the K-means algorithm to cluster the features of the time series segments H₁, which assigns a label l⁽ⁱ⁾ to each instance x⁽ⁱ⁾. Further assign l⁽ⁱ⁾ to the pair (x⁽ⁱ⁾, y⁽ⁱ⁾). In other embodiments, other clustering algorithms can be used while maintaining the spirit of the present invention.

The clusters found in this step include the concepts that are advantageously discovered in accordance with embodiments of the present invention.

FIG. 4 is a block diagram showing an exemplary architecture 400 of the text encoder 215 of FIG. 2, in accordance with an embodiment of the present invention.

The architecture 400 includes a word embedder 411, a position encoder 412, a convolutional layer 413, a normalization layer 421, a convolutional layer 422, a skip connection 423, a normalization layer 431, a self-attention layer 432, a skip connection 433, a normalization layer 441, a feedforward layer 442, and a skip connection 443. The architecture 400 provides an embedded output 450.

The above elements form a transformation network 490.

The input is a text passage. Each token of the input is transformed into word vectors by the word embedding layer 411. The position encoder 412 then appends each token's position embedding vector to the token's word vector. The resulting embedding vector is feed to an initial convolution layer 413, followed by a series of residual convolution blocks 401 (with one shown for the sakes of illustration and brevity). Each residual convolution block 401 includes a batch-normalization layer 421 and a convolution layer 422, and a skip connection 423. Next is a residual self-attention block 402. The residual self-attention block 402 includes a batch-normalization layer 431 and a self-attention layer 432 and a skip connection 433. Next is a residual feedforward block 403. The residual feedforward block 403 includes a batch-normalization layer 441, a fully connected linear feedforward layer 442, and a skip connection 443. The output vector 450 from this block is the output of the entire transformation network and is the feature vector for the input text.

This particular architecture 400 is just one of many possible neural network architectures that can fulfill the purpose of encoding text messages to vectors. Besides the particular implementation above, the text encoder can be implemented using many variants of recursive neural networks or 1-dimensional convolutional neural networks. These and other architecture variations are readily contemplated by one of ordinary skill in the art, given the teachings of the present invention provided herein.

FIG. 5 is a block diagram showing an exemplary architecture 500 of the time series encoder 210 of FIG. 2, in accordance with an embodiment of the present invention.

The architecture 500 includes a word embedder 511, a position encoder 512, a convolutional layer 513, a normalization layer 521, a convolutional layer 522, a skip connection 523, a normalization layer 1031, a self-attention layer 1032, a skip connection 533, a normalization layer 541, a feedforward layer 542, and a skip connection 543. The architecture provides an output 550.

The above elements form a transformation network 590.

The input is a time series of fixed length. The data vector at each time point is transformed by a fully connected layer to a high dimensional latent vector. The position encoder then appends a position vector to each timepoint's latent vector. The resulting embedding vector is feed to an initial convolution layer 513, followed by a series of residual convolution blocks 501 (with one shown for the sakes of illustration and brevity). Each residual convolution block 501 includes a batch-normalization layer 521 and a convolution layer 522, and a skip connection 523. Next is a residual self-attention block 502. The residual self-attention block 502 includes a batch-normalization layer 531 and a self-attention layer 532 and a skip connection 533. Next is a residual feedforward block 503. The residual feedforward block 503 includes a batch-normalization layer 541, a fully connected linear feedforward layer 542, and a skip connection 543. The output vector 550 from this block is the output of the entire transformation network and is the feature vector for the input time series.

This particular architecture 500 is just one of many possible neural network architectures that can fulfill the purpose of encoding time series to vectors. Besides the time-series encoder can be implemented using many variants of recursive neural networks or temporal dilational convolution neural networks.

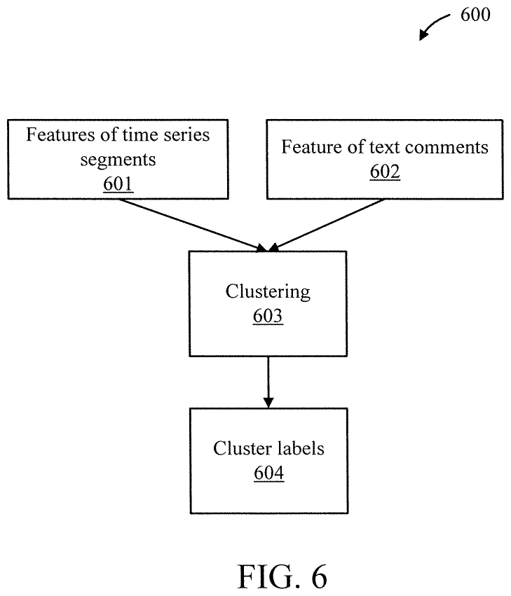

FIG. 6 is a block diagram further showing block 350 of the method 300 of FIG. 3, in accordance with an embodiment of the present invention.

Given features of time series segments 601 and features of text comments 602, perform clustering as per block 350 to obtain cluster labels 603.

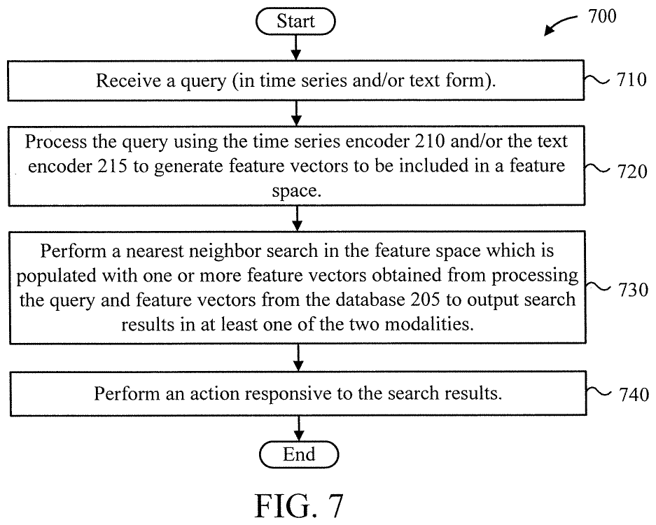

FIG. 7 is a flow diagram showing an exemplary method 700 for cross-modal retrieval, in accordance with an embodiment of the present invention.

At block 710, receive a query in time series and/or text form.

At block 720, process the query using the time series encoder 210 and/or the text encoder 215 to generate feature vectors to be included in a feature space.

At block 730, perform a nearest neighbor search in the feature space which is populated with one or more feature vectors obtained from processing the query and feature vectors from the database 205 to output search results in at least one of the two modalities. In an embodiment, an input modality can be associated with its corresponding output modality in the search results, where the input and output modalities differ or include one or more of the same modalities on either end (input or output, depending upon the implementation and corresponding system configuration to that end as readily appreciated given the teachings provided herein).

At block 740, perform an action responsive to the search results.

Exemplary actions can include, for example, but are not limited to, recognizing anomalies in computer processing systems/power systems and controlling the system in which an anomaly is detected. For example, a query in the form of time series data from a hardware sensor or sensor network (e.g., mesh) can be characterized as anomalous behavior (dangerous or otherwise too high operating speed (e.g., motor, gear junction), dangerous or otherwise excessive operating heat (e.g., motor, gear junction), dangerous or otherwise out of tolerance alignment (e.g., motor, gear junction, etc.) using a text message as a label. In a processing pipeline, an initial input time series can be processed into multiple text messages and then recombined to include a subset of the text messages for a more focused resultant output time series with respect to a given topic (e.g., anomaly type). Accordingly, a device may be turned off, its operating speed reduced, an alignment (e.g., hardware-based) procedure is performed, and so forth, based on the implementation.

Another exemplary action can be operating parameter tracing where a history of the parameters change over time can be logged as used to perform other functions such as hardware machine control functions including turning on or off, slowing down, speeding up, positionally adjusting, and so forth upon the detection of a given operation state equated to a given output time series and/or text comment relative to historical data.

Further regarding block 730 of FIG. 7, in the test phase, with the encoders and the database of raw data and features of both modalities available, nearest-neighbor search can be used to retrieve relevant data for unseen queries.

If the query is a time series segment. Denote it by x. Compute its feature z using the following formulas:

$$h = {g}^{srs} ( x ) \\ z = {h}^{T} {Σ}_{11}^{- \frac{1}{2}} U$$

Alternatively, if the query is a text. Denote it by y. Compute its feature z using the following formulas:

$$h = {g}^{txt} ( y ) \\ z = {h}^{T} {Σ}_{22}^{- \frac{1}{2}} V$$

As noted above, in the test phase, with the encoders 210 and 215 and the database 205 of raw data and features of both modalities available, nearest-neighbor search can be used to retrieve relevant data for unseen queries. The specific procedure for each of three exemplary application scenarios are described below with respect to FIGS. 8-10.

FIG. 8 is a high level block diagram showing an exemplary system/method 800 for providing an explanation of an input time series, in accordance with an embodiment of the present invention.

Given the query 801 as a time series of arbitrary length, it is forward-passed through the time-series encoder 802 to obtain a feature vector x 803. Then from the database 825, find the k text instances whose features 804 have the smallest (Euclidean) distance to this vector (nearest neighbors 805). These text instances, which are human-written free-form comments, are returned as retrieval results 806.

FIG. 9 is a high level block diagram showing an exemplary system/method 900 for retrieving time series based on natural language input, in accordance with an embodiment of the present invention.

Given the query 901 as a free-form text passage (i.e. words or short sentences), it is passed through the text encoder 902 to obtain a feature vector y 903. Then from the database 925, find the k time-series instances whose features 804 have the smallest distance to y (nearest neighbors 905). These time series, which have the same semantic class as the query text and therefore have high relevance to the query, are returned as retrieval results 906.

FIG. 10 is a high level block diagram showing an exemplary system/method 1000 for joint-modality search, in accordance with an embodiment of the present invention.

Given the query as a pair of (time series segment 1001, text description 1002), the time series is passed through the time-series encoder 1003 to obtain a feature vector x 1005, and the text description is passed through the text encoder 1004 to obtain a feature vector y 1006. Then from the database 1025, find the n time series segments whose features 1007 are the nearest neighbors 1008 of x and n time series segments whose features are the nearest neighbors 1008 of y, and obtain their intersection. Start from n=k. If the number of instances in the intersection is smaller than k, increment n and repeat the search, until at least k instances are retrieved. These instances, semantically similar to both the query time series and the query text, are returned as retrieval results 1009.

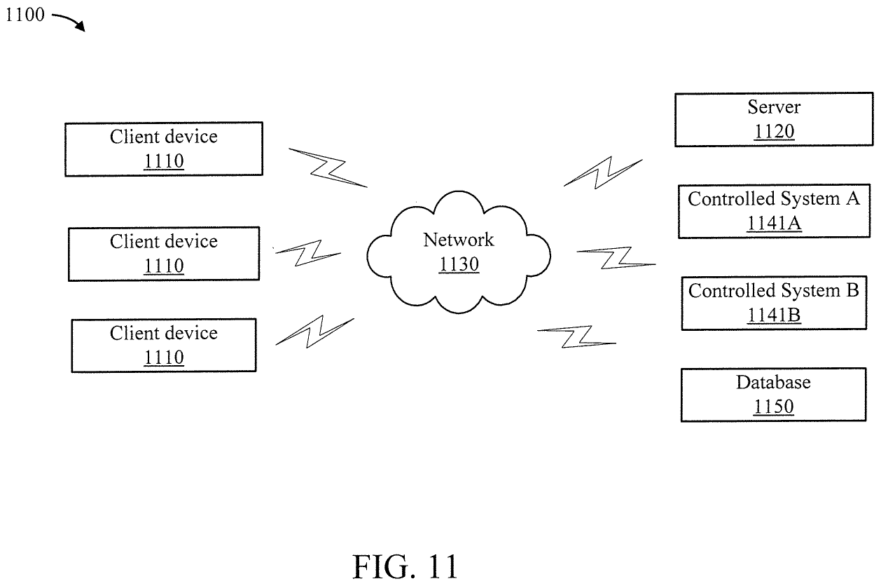

FIG. 11 is a block diagram showing an exemplary computing environment 1100, in accordance with an embodiment of the present invention.

The environment 1100 includes a server 1110, multiple client devices (collectively denoted by the figure reference numeral 1120), a controlled system A 1141, a controlled system B 1142, and a remote database 1150.

Communication between the entities of environment 1100 can be performed over one or more networks 1130. For the sake of illustration, a wireless network 1130 is shown. In other embodiments, any of wired, wireless, and/or a combination thereof can be used to facilitate communication between the entities.

The server 1110 receives queries from client devices 1120. The queries can be in time series and/or text comments form. The server 1110 may control one of the systems 1141 and/or 1142 based on query results derived by accessing the remote database 1150 (to obtain feature vectors for populating a feature space together with feature vectors extracted from the query). In an embodiment, the query can be data related to the controlled systems 1141 and/or 1142 such as, for example, but not limited to sensor data.

While the database 1150 is shown as remote, and envisioned shared amongst multiple monitored systems in a distributed environment (have tens if not possible hundreds of monitored and controlled systems such as 1141 and 1142), in other embodiments the database 1150 can be incorporated into server 1110.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer processing system for cross-modal data retrieval, comprising:
a database for storing training sets of two different modalities of time series and free-form text comments as pairs of mixed modality data;
a neural network having a time series encoder and text encoder which are jointly trained using a canonical correlation analysis that finds transformations of feature vectors from among the pairs of mixed modality data such that correlated mixed modality data is emphasized in the two different modalities and uncorrelated mixed modality data is minimized, the feature vectors obtained by encoding a training set of the time series using the time series encoder and encoding a training set of the free-form text comments using the text encoder; and
a hardware processor for retrieving feature vectors corresponding to at least one of the two different modalities for insertion into a feature space together with at least one feature vector corresponding to a testing input relating to at least one of a testing time series and a testing free-form text comment, determining a set of nearest neighbors from among the feature vectors in the feature space based on distance criteria, and outputting testing results for the testing input based on the set of nearest neighbors.

2. The computer processing system of claim 1, wherein the hardware processor discovers concepts in the times series and the free-form text comments by applying a clustering algorithm to the correlated information.

3. The computer processing system of claim 1, wherein each instance of the times series are within a threshold distance to a counterpart of the free-form text comments in a same multimodal data pair.

4. The computer processing system of claim 1, wherein the transformations are used to form clusters from among the time series and the free-form text comments.

5. The computer processing system of claim 1, wherein the hardware processor maximizes a total correlation between various elements from the training sets using stochastic gradient descent.

6. The computer processing system of claim 1, wherein the feature vectors are obtained by:
computing a time series feature matrix and a free-form text comments feature matrix;
computing a mean feature of the time series and a mean feature of the free form text comments from the matrices; and
centering each of the matrices by subtracting the mean feature corresponding thereto from each of rows of the matrices to provides centered matrices.

7. The computer processing system of claim 1, wherein the canonical correlation analysis is performed using the centered matrices.

8. The computer processing system of claim 1, wherein the database further stores the feature vectors with corresponding ones of the time series and the free-form text comments from which the feature vectors are obtained.

9. The computer processing system of claim 1, where the testing input is an input time series of arbitrary length applied to the time series encoder to obtain the testing results as an explanation of the input time series in a form of one or more free-form text comments.

10. The computer processing system of claim 1, wherein the testing input is an input free-form text comment of arbitrary length applied to the text encoder to obtain the testing results as one or more time series having a same semantic class as the input free-form text comment.

11. The computer processing system of claim 1, wherein the testing input comprise both an input time series of arbitrary length applied to the time series encoder to obtain a first vector for the insertion into the feature space and an input free-form text comment of arbitrary length applied to the text encoder to obtain a second vector for the insertion into the feature space.

12. The computer processing system of claim 1, wherein multiple convolutional layers of the neural network capture local contexts and a transformed network of the neural network captures long term context dependencies relative to the local contexts.

13. The computer processing system of claim 1, wherein the testing input comprises a given time series data at least one hardware sensor for anomaly detection of a hardware system.

14. The computer processing system of claim 13, wherein the hardware processor controls the hardware system responsive to testing results.

15. A computer-implemented method for cross-modal data retrieval, comprising:
storing, in a database, training sets of two different modalities of time series and free-form text comments as pairs of mixed modality data;
jointly training a neural network having a time series encoder and text encoder using a canonical correlation analysis that finds transformations of feature vectors from among the pairs of mixed modality data such that correlated mixed modality data is emphasized in the two different modalities and uncorrelated mixed modality data is minimized, the feature vectors obtained by encoding a training set of the time series using the time series encoder and encoding a training set of the free-form text comments using the text encoder;
retrieving feature vectors corresponding to at least one of the two different modalities for insertion into a feature space together with at least one feature vector corresponding to a testing input relating to at least one of a testing time series and a testing free-form text comment; and
determining a set of nearest neighbors from among the feature vectors in the feature space based on distance criteria, and outputting testing results for the testing input based on the set of nearest neighbors.

16. The computer-implemented method of claim 15, further comprising discovering concepts in the times series and the free-form text comments by applying a clustering algorithm to the correlated information.

17. The computer-implemented method of claim 15, wherein each instance of the times series are within a threshold distance to a counterpart of the free-form text comments in a same multimodal data pair.

18. The computer-implemented method of claim 15, wherein the transformations are used to form clusters from among the time series and the free-form text comments.

19. The computer-implemented method of claim 15, further comprising maximizing a total correlation using stochastic gradient descent.

20. A computer program product for cross-modal data retrieval, the computer program product comprising a non-transitory computer readable storage medium having program instructions embodied therewith, the program instructions executable by a computer to cause the computer to perform a method comprising:
storing, in a database, training sets of two different modalities of time series and free-form text comments as pairs of mixed modality data;
jointly training a neural network having a time series encoder and text encoder using a canonical correlation analysis that finds transformations of feature vectors from among the pairs of mixed modality data such that correlated mixed modality data is emphasized in the two different modalities and uncorrelated mixed modality data is minimized, the feature vectors obtained by encoding a training set of the time series using the time series encoder and encoding a training set of the free-form text comments using the text encoder;
retrieving feature vectors corresponding to at least one of the two different modalities for insertion into a feature space together with at least one feature vector corresponding to a testing input relating to at least one of a testing time series and a testing free-form text comment; and
determining a set of nearest neighbors from among the feature vectors in the feature space based on distance criteria, and outputting testing results for the testing input based on the set of nearest neighbors.
